(19) United States
(12) Patent Application Publication
(10) Pub. No.: US 2026/0323232 A1
(43) Pub. Date: Oct. 15, 2026

(54) USER-FRIENDLY METHOD OF MULTICHANNEL SPATIAL POSITION CALIBRATION USING PLEASANT AUDIO

(71) Applicant: HARMAN INTERNATIONAL INDUSTRIES, INCORPORATED, Stamford, CT (US)

(72) Inventors: Hongyi ZHU, Shenzhen, Guangdong (CN); Jianwen ZHENG, Shenzhen, Guangdong (CN)

(73) Assignee: HARMAN INTERNATIONAL INDUSTRIES, INCORPORATED, Stamford, CT (US)

(21) Appl. No.: 19/484,972

(22) PCT Filed: May 19, 2023
(86) PCT No.: PCT/CN2023/095249

§ 371 Date: Nov. 17, 2025

(51) Int. Cl. H04S 7/00

(52) U.S. Cl. CPC H04S 7/301

(57) ABSTRACT

A multi-channel spatial position calibration method using pleasant audio such as music or speech is provided, which is more acceptable and user-friendly for users. The method may calibrate the multi-channel spatial distribution through LMS-based RIR estimation and cross-correlation-based DOA estimation. A multi-channel sound system applicable for the method is also provided.

### TECHNICAL FIELD

The present inventive subject matter relates generally to signal processing. More particularly, the present inventive subject matter relates to a user-friendly method of multichannel spatial position calibration using pleasant audio and a multi-channel sound system applicable therefor.

### BACKGROUND

Nowadays, multi-channel sound reproduction has become more and more popular, such as stereo, 5.1, 7.1, and the like. The orderly distribution of a plurality of discrete speakers in a multi-channel sound system has become a prerequisite for achieving the multichannel sound reproduction. In the past, traditional layouts that used wired distribution usually required professional personnel to arrange to ensure that each speaker could be placed in the correct position and order. Although fewer error may occur, laying out in a wired manner is not only cumbersome but also increases labor costs. Nowadays, wired connections have gradually been replaced wireless connections, which means that the plurality of speakers can be grouped together in the same wireless network. In the meantime, how to correctly identify and set the channel sequence of the plurality of discrete speakers becomes a new issue.

To calibrate the relative position of the plurality of discrete speakers in a multi-channel audio system, a passive way is to mark the product with labels, such as ‘L’ for left, ‘R’ for right, and require the user to manually place each of the speakers in the correct position. This method is convenient for manufacturers, but very unfriendly to users. Another effective method is to automatically recognize the spatial position of each speaker relative to other speakers, which is more intelligent, but also more complex, making it difficult to ensure the accuracy of calibration.

In addition, many portable speakers have been featured with the “stereo mode” that can realize L&R channel recognition using calibration tones, such as chirp tones, as calibration audio. However, the calibration tones may be considered unpleasant and a bit annoying. Due to these calibration chirp tones, the volume of calibrated tones is usually limited at the expense of calibration accuracy. In view of such situation, to have better experiences for users and to guarantee calibration accuracy, it becomes a natural desire to calibrate the spatial distribution of the plurality of discrete speakers using louder and more pleasant audio, such as music or speech, than those harsh chirps used as the calibration tones in the prior art.

### SUMMARY OF THE INVENTIVE SUBJECT MATTER

In one aspect, a user-friendly method of multi-channel spatial position calibration using pleasant audio in a multi-channel sound system is provided. The multi-channel sound system comprises a plurality of speakers each with a microphone array built-in. The user-friendly method comprises steps of receiving and storing calibration signals, by the microphone array of each speaker of the plurality of speakers, from the plurality of speakers. The user-friendly method comprises steps of configuring each speaker of the plurality of speakers to estimate room impulse responses (RIRs) of each of the speakers of the plurality of speakers relative to the speaker itself and relative to all of the other speakers of the plurality of speakers, calculate distances between the each speaker and the other speakers of the plurality of speakers, estimate directions of arrival (DOA) of the received calibration signals from the other speakers of the plurality of speakers, and convey the estimated RIRs, the calculated distances and the estimated DOAs to a primary speaker of the plurality of speakers. Moreover, the user-friendly method further comprises a step of configuring the primary speaker to calibrate multi-channel spatial distribution of the multi-channel sound system, wherein the calibration signals can be pleasant audio.

In another aspect, a multi-channel sound system for multi-channel spatial position calibration using pleasant audio. The multi-channel sound system comprises a plurality of speakers each with a microphone array built-in, wherein each speaker of the plurality of speakers can be configured to receive and store calibration signals, by the microphone array in each speaker, from the plurality of speakers. Each speaker of the plurality of speakers can be further configured to estimate RIRs of each of the speakers of the plurality of speakers relative to the speaker itself and relative to all of the other speakers of the plurality of speakers, calculate distances between each one of the speakers of the plurality of speakers and the other speakers of the plurality of speakers, estimate DOAs of the received calibration signals from the other speakers of the plurality of speakers, and convey the estimated RIRs, the calculated distances and the estimated DOAs to a primary speaker of the plurality of speakers. The primary speaker can be further configured to calibrate multi-channel spatial distribution of the multi-channel sound system, wherein the calibration signals can be pleasant audios.

### BRIEF DESCRIPTION OF THE DRAWINGS

The present inventive subject matter may be better understood from reading the following description of non-limiting embodiments, with reference to the attached drawings. In the figures, like reference numeral designates corresponding parts, wherein below:

FIG. 1 illustrates a schematic diagram of a multi-channel sound system for a multi-channel spatial position calibration method according to one or more embodiments of the present inventive subject matter;

FIG. 2 illustrates an exemplary block diagram of the multichannel spatial position calibration processing according to one or more embodiments of the present inventive subject matter;

FIG. 3 illustrates an exemplary flowchart of the multi-channel spatial position calibration method according to one or more embodiments of the present inventive subject matter;

FIG. 4 illustrates an exemplary framework of the RIR identification system according to one or more embodiments of the present inventive subject matter;

FIG. 5 illustrates a schematic diagram of a direct sound and some reflected sounds propagated between a speaker playing calibration signals and a microphone receiving thereof according to one or more embodiments of the present inventive subject matter;

FIG. 6A illustrates an exemplary graphical RIR recorded by a microphone array of one speaker in a plurality of speakers from the speaker itself, according to one or more embodiments in the present inventive subject matter;

FIG. 6B illustrates an exemplary graphical RIR recorded by the microphone array of the speaker in the plurality of speakers in FIG. 6A but from another speaker in the plurality of speakers, according to one or more embodiments in the present inventive subject matter; and

FIG. 7 illustrates a schematic diagram of the DOA estimation based on TDOA between microphones according to one and more embodiments of the present inventiveness subject.

### DETAILED DESCRIPTION

The detailed description of the one or more embodiments of the present inventive subject matter is disclosed hereinafter; however, it is understood that the disclosed embodiments are merely exemplary of the inventive subject matter that may be embodied in various and alternative forms. The figures are not necessarily to scale; some features may be exaggerated or minimized to show details of particular components. Therefore, specific structural and function details disclosed herein are not to be interpreted as limiting, but merely as a representative basis for teaching one skilled in the art to variously employ the present inventive subject matter.

A multi-channel sound system usually comprises a plurality of discrete speakers, each of the speakers may reproduce, for example, one channel of stereo sound. In some instances, without considering the subwoofer, the 5.1 surround sound system may include 5 speakers, while the 7.1 surround sound system may include 7 speakers. During the installation and the usage of the multi-channel sound system, it is essential to consider compensating for the acoustic differences generated among each channel in different listening spaces and room furnishings. Therefore, the multi-channel spatial position calibration is necessary. In this calibration process, the spatial distribution between each pair of the speakers should be ascertained first before processing sound compensation.

In the present inventive subject matter, a user-friendly method of multichannel spatial position calibration based on RIR Estimation and cross-correlation analysis using pleasant audio is provided.

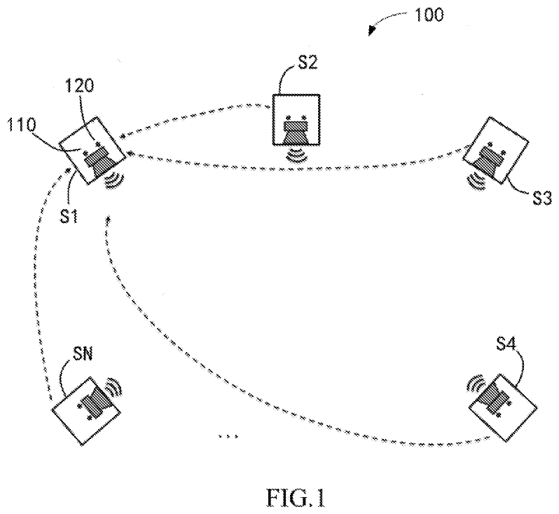

FIG. 1 illustrates a schematic diagram of a multi-channel sound system 100 for a multi-channel spatial position calibration method according to one or more embodiments of the present inventive subject matter. As shown in FIG. 1, in a wireless network, there are N speakers in the multi-channel sound system, labeled as S1, S2, S3, S4, . . . , SN, in each of which a microphone array with at least two microphones 110, 120 is embedded built-in. These N speakers may be grouped in the same wireless network in a certain sequence, which may be inconsistent with their actual arrangement order. Firstly, the N speakers may be divided into a single primary speaker, such as S1, and other secondary speakers including such as S2, S3, . . . , SN. In a way of example, in the 5.1 surround sound system, the center channel speaker may be set as the primary speaker, and the other left, right, left surround, and right surround speakers as secondary speakers. In other examples, a different speaker can be set as the primary with the others as the secondary speakers.

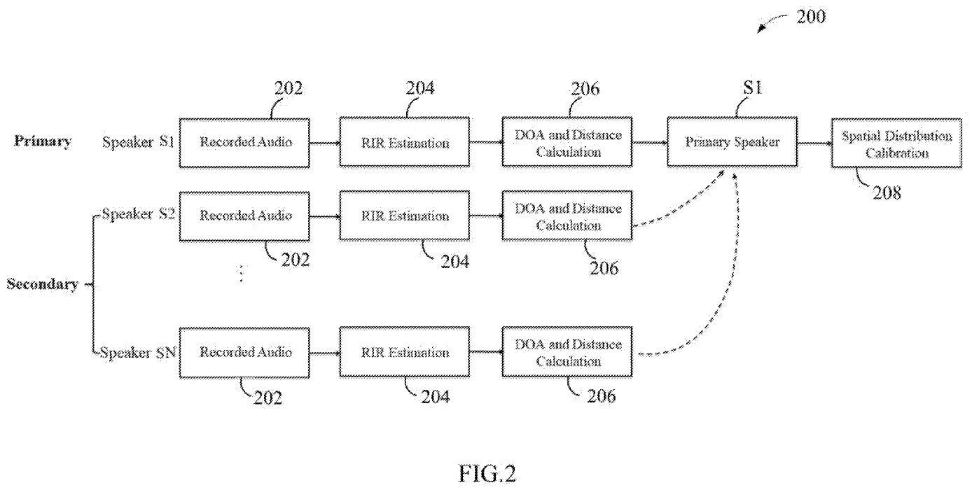

The object of the present inventiveness subject matter is for the primary speaker, such as the speaker 1 in the example as shown in FIG. 1, to calibrate the spatial distribution and correct the order of all the speakers of the multi-channel sound system through the DOA and Distance information of each of the speakers therefrom conveyed to the primary speaker. FIG. 2 illustrates an exemplary block diagram 200 of the multichannel spatial position calibration processing according to one or more embodiments of the present inventive subject matter. As can be seen from FIG. 2, each one of the speakers S1 to SN can be configured to keep recording 202 the calibration audios during the entire period of the calibration, and calculate the RIR estimation 204 of itself and the RIR of the other speakers through the recorded calibration audio. Then the distance information can be calculated by analyzing the absolute timings of direct sound in the RIRs, and the DOA information can be estimated 206 based on correlation analysis of the RIRs. Afterwards, the secondary speakers convey all the estimated distance and the DOA information through the network to the primary speaker. The primary speaker performs the spatial distribution calibration 208 and corrects the order of all N speakers, to achieve the multi-channel spatial position calibration.

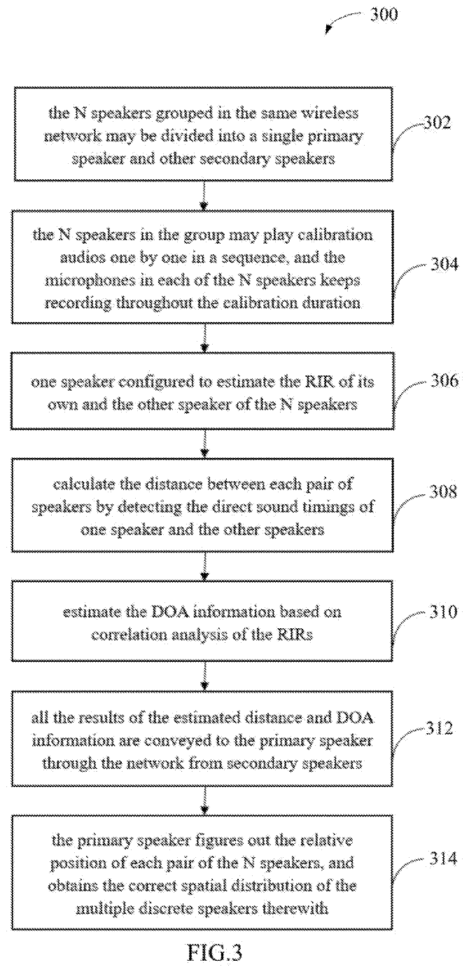

FIG. 3 illustrates an exemplary flowchart 300 of the multi-channel spatial position calibration method according to one or more embodiments of the present inventive subject matter.

In Step 302, the N speakers grouped in the same wireless network may be divided into a single primary speaker and other secondary speakers, as previously described in such relevant details with reference to FIG. 1.

In Step 304, the N speakers in the group may play calibration audios one by one in a sequence, for example, as the sequence indicated with the labels of the speakers shown in FIG. 1, and the microphone array in each of the N speakers keeps recording, respectively, throughout the entire calibration duration. Therefore, it can be understood that, for every one of the N speakers in doing so, the calibration signals broadcast from each of all the N speakers can be received and stored, respectively, by the microphones built therein. The each of the N speakers then may be configured to estimate the RIR for itself and the RIR of the other speakers in Step 306, calculate the distance information through analyzing the absolute timings of direct sound in the RIRs in Step 308, and estimate the DOA information based on correlation analysis of the RIRs in Step 310, as shown in FIG. 3.

In the one or more embodiments of the present inventive subject matter, operations of a microphone array, or one or more microphones, built in a speaker can be interchangeably referred via weighted or averaged processing for the microphones therein, unless specifically addressing differences in each microphone in the microphone array, such as but not limited to the TDOA estimation, which will be described below, in the one or more embodiments of the present inventive subject matter.

It can be seen that in the steps described above for the multi-channel spatial position calibration method provided in the inventive subject matter, the operation performed by each speaker can be generally the same. In this case, any pair of speakers can be picked out of the N speakers to illustrate as the representative example. In the one or more embodiments of the present inventive subject matter, the pair of speakers S1, S2 of the N speakers are selected as the representative exemplary speakers to describe the relative spatial positioning of the N speakers.

In particular, with the recorded calibration audios, one speaker in the pair may estimate the RIR of itself and the RIR of another speaker, as described in Step 306 of FIG. 3. The sound wave from the speaker to the microphone will pass through a certain spatial path, which is equivalent to convolving a RIR. There has been much research on RIR measurement based on different test signals, among which typically include chirp, noise, music and speech signals. The advantage of the first two kinds of signals is that the measurement results are more accurate and stable, but the test signals are a bit annoying which are unfriendly to users. The latter two kinds of signals are more friendly with decreased accuracy of measurement, but it is sufficient to meet the requirements of multichannel spatial position calibration discussed in the present inventive subject matter. For such calibration signals composed of these music or speech, certain processing shall be required for the RIR estimation.

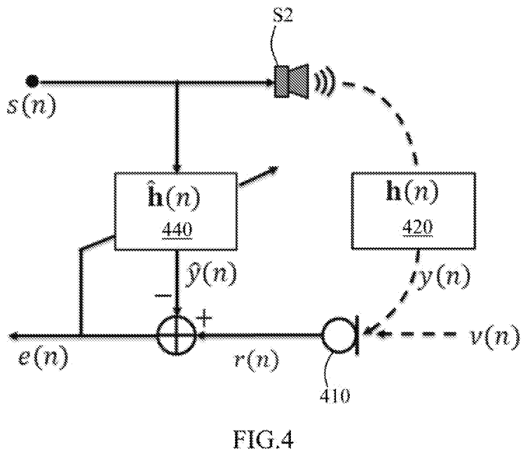

FIG. 4 illustrates an exemplary framework of the RIR identification system according to one or more embodiments of the present inventive subject matter.

With taking the pair of speakers S1, S2 of the N speakers as an example in the one or more embodiments of the present innovative subject matter, the calibration signal s(n) broadcast from the speaker S2 goes through the spatial path 420 with a transfer function h(n), providing the desired signal y(n). The measured signal r(n) by the microphone 410 contains the desired signal y(n) and unwanted noise v(n) (such as the system noise, environment noise, etc.). The transfer function h(n) can be approximated by introduced an adaptive filter 440 with an estimated transfer function h(n), aiming to produce an estimate of the desired signal f(n). The input signal, i.e., the calibration signal s(n) can be filtered with the filter coefficients, collectively denoted with the estimated transfer function h(n), and subtracted from the measured microphone signal r(n). Then, the resulting error e(n) may be used to update h(n) through minimizing the error signal energy, iteratively.

Accordingly, referring to FIG. 4, the microphone signal r(n) for the adaptive filter 440 may be formulated as follows:

r(n)=y(n)+v(n)=s(n)^{T}h(n)+v(n) (1)
Where the superscript T denotes transposition. h(n)=[h₀(n),h₁(n), . . . , h_{L-1}(n)]^{T} is finite impulse response (FIR) with length L, s(n)=[s(n),s(n−1), . . . , s(n−L+1)]^{T} is a real-valued vector containing the L most recent time samples of the input signal, s(n).

Therefore, the error signal can be calculated as below,

e(n)=r(n)−s(n)^{T}ĥ(n)=s(n)^{T}[h(n)−ĥ(n)]+v(n) (2)

In the present inventive subject matter, Least Means Square (LMS) algorithms can be further provided to update the estimated transfer function h(n) established by the adaptive filter 440 with robustness and high stability and reasonably fast convergence rates, and it can be realized either in time domain or in frequency domain. The updating of the adaptive filter is a computationally simple process, which can be accomplished in real-time on even a modest portable computing device.

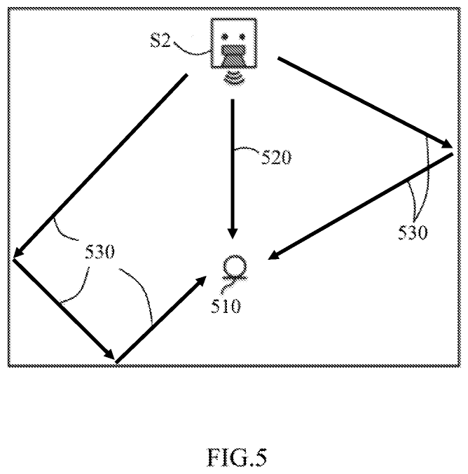

The microphone signals contain the spatial information of direct and reflected sound, which can be clearly seen from FIG. 5, and so do RIRs. FIG. 5 illustrates a schematic diagram of a direct sound and some reflected sounds propagated between a speaker playing calibration signals and a microphone receiving thereof according to one or more embodiments of the present inventive subject matter. In FIG. 5, the example of the one or more embodiments, it is represented by the microphone (array), labeled as 510, in the speaker S1, to receive the calibration signal from the speaker S2. As shown in FIG. 5, a direct sound 520 and some reflected sounds 530 can be received. The absolute timings of direct sound in a RIR can be used to detect the distance between a speaker and a microphone. That is, the distance between each pair of speakers can be calculated by detecting the direct sound timings of itself and the direct sound timings of other speakers, as described in Step 308 of FIG. 3.

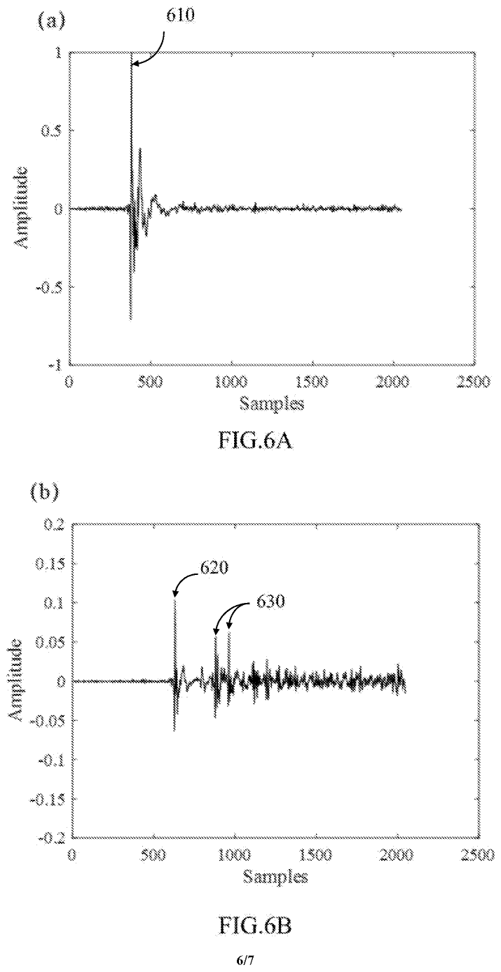

FIGS. 6A and 6B illustrate two exemplary graphical RIRs recorded by a microphone array of one speaker in a plurality of speakers from the speaker itself, and from another speaker, respectively, according to one or more embodiments in the present inventive subject matter. The two exemplary graphical RIRs both are illustrated with reference to a coordinate system with the same scale plotted in terms of amplitude vs. number of samples per second for the calibration signal. In the one or more embodiments of the present innovative subject matter represented by the pair of speakers S1, S2 of the N speakers, FIG. 6A illustrates an RIR recording from the speaker S1 to the microphone array built into the speaker S1. It can be seen that the primary peak marked 610 depicts the timing of direct sound received from the speaker S1. FIG. 6B illustrates an RIR recording from the other speaker S2 to the microphone array in speaker S1, wherein the first primary peak marked as 620 depicts the timing of direct sound received from the speaker S2, and other peaks collectively marked as 630 depict timing of reflected sounds received. It takes less time for the direct sound to travel to the microphone than the reflected sounds. Therefore, the distance d_{AB} between speaker S1 and speaker S2 can be represented as equation (3) as follow, with ignoring the distance between speaker S1 and the microphone array therein:

d_{AB}=Δn_{AB}fₛ·c (3)
Where Δn_{AB} is the sample difference between the two timings of direct sound 1 and 2, fₛ is the sampling rate, c is the sound velocity.

The spatial position calibration of the plurality of discrete speakers mostly depends on the source localization, which includes two parts, one is the distance between speakers, the other is the directions of arrival of the sound sources.

In the present inventive subject matter, it is critical for the microphone array of each speaker to estimate time delays between the received calibration signals among the microphones, in which the cross-correlation analysis can be adopted to provide considerable accuracy in estimating time delay between the microphones. However, in practical situations, the estimation of this time delay may be disturbed by the presence of reflected sounds in the room. Therefore, the DOA estimation in complex environments remains a highly challenging task.

As mentioned earlier, using DOA estimation to automatically identify the spatial position of each speaker relative to other speakers is a more intelligent and complex calibration method. As illustrated in FIG. 1, the calibration audio is broadcasted by each speaker in sequence and recorded with microphones embedded in the products. With the recorded audio, DOA information of each speaker can be estimated to calibrate the spatial distribution of the plurality of discrete speakers.

For the DOA estimation as illustrated in Step 310 of FIG. 3, a direct approach can be used to compute the cost function in a set of candidate directions and to select the most likely source direction, which however requires heavy calculation. On the other hand, in one or more embodiments of the present inventive subject matter, an indirect method can be adopted to estimate the time difference of arrival (TDOA) between microphones, and then to estimate the source position through optimization techniques based on the array geometry. Such method has less computational complexity, higher positioning accuracy, and can be easy to implement in real-time systems, and therefore can be advantageous for DOA estimation.

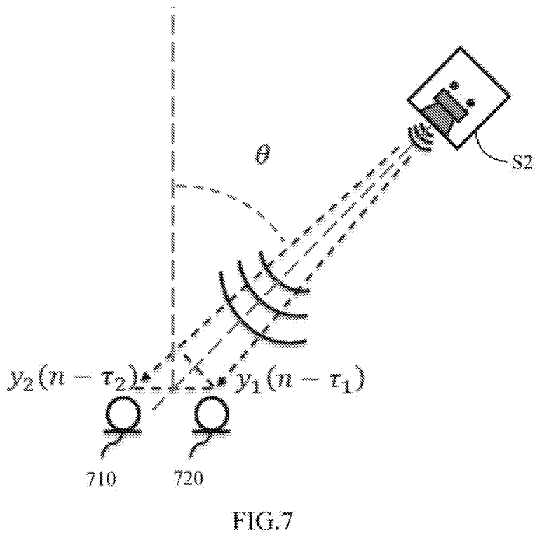

FIG. 7 illustrates a schematic diagram of the DOA estimation based on TDOA between microphones according to one and more embodiments of the present inventiveness subject. Assuming the discrete event signal model of the signals received by the two microphones 710 and 720 in the microphone array of one speaker (the speaker S1 in the pair of speakers S1, S2 of the N speakers in the one and more embodiments) is as follow:

$$\{ \begin{matrix}{r}_{1} ( n ) = {y}_{1} ( n - {τ}_{1} ) + {v}_{1} ( n ) \\ {r}_{2} ( n ) = {y}_{2} ( n - {τ}_{2} ) + {v}_{2} ( n )\end{matrix} \qquad ( 4 )$$

τ₁ and τ₂ are the travel time of acoustic wave transmitted from the sound source (the other speaker S2 in the one and more embodiments) to the first microphone 710 and the second microphone 720 built in the speaker S1, which are preserved in the RIRs, represented as RIR₁(n) and RIR₂(n), and τ₁₂=τ₁−τ₂ denotes the time delay between the two microphones 710, 720. In the present inventive subject matter, correlation analysis can be adopted to compare the similarity between the two signals between the two microphones 710, 720 in time domain. It should be noticed that, to improve the accuracy of the TDOA estimation, the RIRs may be preprocessed by using a time window to select a portion of the direct sound and applying a smoothing function to minimize the influence of reflected sound, so as to eliminate interference from the received reflected sounds, such as previously shown by the reflected sounds 530 in FIG. 5 with retaining the direct sound 520 to calculate the TDOA herein.

Accordingly, the correlation function R₁₂(τ) of the two preprocessed RIRs can be expressed as:

R₁₂(τ)=E(RIR₁(n-τ₁)RIR₂(n-τ₂-τ))=Rₛ(τ−(τ₁-τ₂)) (5)

It may be determined by the properties of the autocorrelation function that, when τ=τ₁−τ₂, equation (5) is of the maximum. Therefore, the TDOA between the two microphones 710, 720 can be estimated as the time lag that maximizes the cross-correlation between the RIRs of such two signals y₁(n−τ₁) and y₂(n−τ₂). The DOA may be calculated as below:

$$θ = a sin ( \frac{- ( {τ}_{1} - {τ}_{2} ) / {f}_{s} \cdot c}{{d}_{Mic}} ) \qquad ( 6 )$$

Where d_{Mic} is the spacing between microphone 710 and microphone 720.

So far, in the N speakers of the multiple-channel sound system, each speaker has obtained the RIRs, the estimated relative distances and the DOA information for itself and from all the other speakers. In the next Step 312, the primary speaker of the N speaker may receive those results conveyed by each of the secondary speakers, that is, all these results of the estimated distance and DOA information are conveyed to the primary speaker through the network. And in Step 314, with the collected information, the primary speaker can be able to figure out the relative position of each pair of the N speakers, and together with the estimated distance, the correct spatial distribution of the plurality of discrete speakers can be obtained.

In summary, the present inventive subject matter focuses to provide a framework design that facilitates automated calibration of speakers for multi-channel spatial reproduction. Through the techniques discussed above, the spatial position calibration of the multi-channel sound system based on pleasant audios (such as music or voice signals) can be achieved by positioning each of the plurality of discrete speakers with therein.

The multi-channel spatial position calibration method based on pleasant audio such as music or speech provided in the subject matter of the present inventive subject matter is more acceptable and user-friendly for users. The technical solution of the present inventive subject matter can be broken down as the following:
(1) Spatial position calibration using pleasant audio like music or speech.
(2) LMS-based RIR estimation.
(3) Cross-correlation-based DOA estimation.

In particular, the RIR estimation performed using robust LMS algorithm may be more stable for the timing of user detection of direct and reflected sound, which helps to calculate the distance between each pair of speakers and also reduces the impact of reflected sound on DOA estimation. Moreover, by applying a cross correlation function to preprocess RIR, the DOA of each speaker relative to other speakers can be obtained more accurately. By combining various techniques mentioned above, the spatial position of each speaker can be completely determined, thus achieving automatic calibration of multi-channel spatial distribution.

Any combination of one or more computer-readable media may be used to perform the method provided in one and more embodiments of the present inventive subject matter. The computer-readable medium may be a computer-readable signal medium or a computer-readable storage medium. The computer-readable storage medium may be, for example, but not limited to, an electronic, magnetic, optical, electromagnetic, infrared, or semiconductor system, apparatus, or device, or any suitable combination of the foregoing. More specific examples (non-exhaustive list) of the computer-readable storage medium may include, for example: an electrical connection with one or more wires, portable computer floppy disks, hard disks, random access memory (RAM), read-read-only memory (ROM), erasable programmable read only memory (EPROM or flash memory), optical fibers, portable compact disc read only memory (CD-ROM), optical storage devices, magnetic storage devices, or any suitable combinations of the foregoing. In the context of the disclosure, the computer-readable storage medium may be any tangible medium that can include or store a program for use by or in connection with an instruction execution system, apparatus, or device.

As used in the disclosure, an element or step listed in the singular form and preceded by the word “one/a” should be understood as not excluding a plurality of said elements or steps, unless such exception is specifically stated. Furthermore, references to “embodiments” or “examples” of the disclosure are not intended to be construed as exclusive, also including the existence of other embodiments of the recited features. The terms “first”, “second”, “third”, etc. are used only for identification and are not intended to emphasize a numerical requirement or positioning order of their objects.

References in the present inventive subject matter to the multi-channel spatial positioning calibration using pleasant audio for the multi-channel sound systems include the following content:

Item 1: In one or more embodiments, the present inventive subject matter provides a user-friendly method of multi-channel spatial position calibration using pleasant audio in a multi-channel sound system, the multi-channel sound system comprising a plurality of speakers each with a microphone array, the user-friendly method comprising steps of:
receiving and storing calibration signals, by the microphone array of each speaker of the plurality of speakers, from the plurality of speakers;
configuring each speaker of the plurality of speakers to:
   estimate room impulse responses (RIRs) from one speaker of the plurality of speakers to the microphone array built into the one speaker and from the other speakers of the plurality of speakers to the microphone array built into the one speaker;
   calculate distances between each speaker and the other speakers of the plurality of speakers;
   estimate directions of arrival (DOA) of the received calibration signals from the other speakers of the plurality of speakers, and
   convey the estimated RIRs, the calculated distances and the estimated DOAs to a primary speaker of the plurality of speakers, and
configuring the primary speaker to perform multi-channel spatial calibration for the multi-channel sound system,
wherein the calibration signals can be pleasant audio.

Item 2. The method of item 1, wherein the steps or the method further comprises playing, by each speaker of the plurality of speakers, the calibration signals one by one in sequence.

Item 3. The method of item 1 or 2, wherein the microphone array comprises at least two microphones.

Item 4. The method of any of items 1-3, wherein the DOA can be estimated by estimating time difference of arrival (TDOA) between the at least two microphones.

Item 5. The method of any of items 1-4, wherein the TDOA can be estimated as the time lag that maximizes cross-correlation between the RIRs of the at least two microphones.

Item 6. The method of any of items 1-5, wherein the RIRs can be estimated by introducing an adaptive filter to establish an estimated transfer function to approximate the transfer function of the spatial path between each speaker and each of the other speakers of the plurality of speakers.

Item 7. The method of any of items 1-6, wherein the estimated transfer function can be updated iteratively using Least Means Square (LMS) algorithms.

Item 8. The method of any of items 1-7, wherein the multi-channel spatial calibration can be performed by figuring out a relative position of each pair of the plurality of speakers to obtain a correct spatial distribution thereof.

Item 9. The method of any of items 1-8, wherein the pleasant audio comprises music.

Item 10. The method of any of items 1-9, wherein the pleasant audio comprises speech.

Item 11. In one or more embodiments, the present inventive subject matter provides a multi-channel sound system for multi-channel spatial position calibration using pleasant audio, comprising:
plurality of speakers each with a microphone array, wherein each speaker of the plurality of speakers can be configured to:
   receive and store calibration signals, by the microphone array in each speaker, from the plurality of speakers;
   estimate room impulse responses (RIRs) from one speaker of the plurality of speakers to the microphone array built in the one speaker and from the other speakers of the plurality of speakers to the microphone array built in the one speaker;
   calculate distances between one speaker and the other speakers of the plurality of speakers;
   estimate directions of arrival (DOA) of the received calibration signals from the other speakers of the plurality of speakers, and
   convey the estimated RIRs, the calculated distances and the estimated DOAs to a primary speaker of the plurality of speakers, and
wherein the primary speaker is further configured to perform multi-channel spatial calibration for the multi-channel sound system, and
wherein the calibration signals can be pleasant audio.

Item 12. The multi-channel sound system of item 11, wherein each of the plurality of speakers plays the calibration signals one by one in sequence.

Item 13. The multi-channel sound system of item 11 or 12, wherein the microphone array comprises at least two microphones.

Item 14. The multi-channel sound system of any of items 11-13, wherein the DOA can be estimated by estimating time difference of arrival (TDOA) between the at least two microphones.

Item 15. The multi-channel sound system of any of items 11-14, wherein the TDOA can be estimated as the time lag that maximizes cross-correlation between the RIRs of the at least two microphones.

Item 16. The multi-channel sound system of any of items 11-15, wherein the RIRs can be estimated by introducing an adaptive filter to establish an estimated transfer function to approximate the transfer function of a spatial path between each speaker and each of the other speakers of the plurality of speakers.

Item 17. The multi-channel sound system of any of items 11-16, wherein the estimated transfer function can be updated iteratively using Least Means Square (LMS) algorithms.

Item 18. The multi-channel sound system of any of items 11-17, wherein the multi-channel spatial calibration can be performed by figuring out a relative position of each pair of the plurality of speakers to obtain a correct spatial distribution thereof.

Item 19. The multi-channel sound system of any of items 11-18, wherein the pleasant audio comprises music.

Item 20. The multi-channel sound system of any of items 11-19, wherein the pleasant audio comprises speech.

1. A method of multi-channel spatial position calibration using pleasant audio in a multi-channel sound system, the multi-channel sound system comprising a plurality of speakers each with a microphone array, the user-friendly method comprising steps of:
receiving and storing calibration signals, by the microphone array of each speaker of the plurality of speakers, from the plurality of speakers;
configuring each speaker of the plurality of speakers to:
estimate room impulse responses (RIRs) from one speaker of the plurality of speakers to the microphone array built into the one speaker and from the other speakers of the plurality of speakers to the microphone array built into the one speaker;
calculate distances between each speaker and the other speakers of the plurality of speakers;
estimate directions of arrival (DOA) of the received calibration signals from the other speakers of the plurality of speakers, and
convey the estimated RIRs, the calculated distances and the estimated DOAs to a primary speaker of the plurality of speakers, and
configuring the primary speaker to perform multi-channel spatial calibration for the multi-channel sound system,
wherein the calibration signals comprise pleasant audio.

2. The method of claim 1, wherein the steps or the user-friendly method further comprises playing, by each speaker of the plurality of speakers, the calibration signals one by one in sequence.

3. The method of claim 1, wherein the microphone array comprises at least two microphones.

4. The method of claim 3, wherein the DOA is estimated by estimating time difference of arrival (TDOA) between the at least two microphones.

5. The method of claim 4, wherein the TDOA is estimated as the time lag that maximizes cross-correlation between the RIRs of the at least two microphones.

6. The method of claim 1, wherein the RIRs is estimated by introducing an adaptive filter to establish an estimated transfer function to approximate the transfer function of a spatial path between one speaker and each of the other speakers of the plurality of speakers.

7. The method of claim 6, wherein the estimated transfer function is updated iteratively using Least Means Square (LMS) algorithms.

8. The method of claim 1, wherein the multi-channel spatial calibration is performed by figuring out a relative position of each pair of the plurality of speakers to obtain a correct spatial distribution thereof.

9. The method of claim 1, wherein the pleasant audio comprises music.

10. The method of claim 1, wherein the pleasant audio comprises speech.

11. A multi-channel sound system for multi-channel spatial position calibration using pleasant audio, comprising:
a plurality of speakers each with a microphone array, wherein each speaker of the plurality of speakers is configured to:
receive and store calibration signals, by the microphone array in each speaker, from the plurality of speakers;
estimate room impulse responses (RIRs) from one speaker of the plurality of speakers to the microphone array built into the one speaker and from the other speakers of the plurality of speakers to the microphone array built into the one speaker;
calculate distances between each speaker and the other speakers of the plurality of speakers;
estimate directions of arrival (DOA) of the received calibration signals from the other speakers of the plurality of speakers, and
convey the estimated RIRs, the calculated distances and the estimated DOAs to a primary speaker of the plurality of speakers, and
wherein the primary speaker is further configured to perform multi-channel spatial calibration for the multi-channel sound system, and
wherein the calibration signals comprise pleasant audio.

12. The multi-channel sound system of claim 11, wherein each of the plurality of speakers plays the calibration signals one by one in sequence.

13. The multi-channel sound system of claim 11, wherein the microphone array comprises at least two microphones.

14. The multi-channel sound system of claim 13, wherein the DOA is estimated by estimating time difference of arrival (TDOA) between the at least two microphones.

15. The multi-channel sound system of claim 14, wherein the TDOA is estimated as the time lag that maximizes cross-correlation between the RIRs of the at least two microphones.

16. The multi-channel sound system of claim 11, wherein the RIRs is estimated by introducing an adaptive filter to establish an estimated transfer function to approximate the transfer function of a spatial path between each speaker and each of the other speakers of the plurality of speakers.

17. The multi-channel sound system of claim 16, wherein the estimated transfer function is updated iteratively using Least Means Square (LMS) algorithms.

18. The multi-channel sound system of claim 11, wherein the multi-channel spatial calibration is performed by figuring out a relative position of each pair of the plurality of speakers to obtain a correct spatial distribution thereof.

19. The multi-channel sound system of claim 11, wherein the pleasant audio comprises music.

20. The multi-channel sound system of claim 11, wherein the pleasant audio comprises speech.
